(19) United States
(12) Patent Application Publication
(10) Pub. No.: US 2025/0362863 A1
(43) Pub. Date: Nov. 27, 2025

(54) Multi-Host Redundant Audio Interface System with Real-Time Vocal Pitch Correction and Enhanced Signal Processing

(71) Applicant: APOGEE ELECTRONICS CORPORATION, SANTA MONICA, CA (US)

(72) Inventor: Betty Ann Bennett, Pacific Palisades, CA (US)

(21) Appl. No.: 18/671,933

(22) Filed: May 22, 2024

(51) Int. Cl. G06F 3/16; G10H 1/00; G10H 1/36

(52) U.S. Cl. CPC G06F 3/162; G10H 1/0066; G10H 1/366

(57) ABSTRACT

An audio interface comprises a CPU (central processing unit) that includes a DSP (digital signal processor), a MIDI (musical instrument digital interface) processor, and two Voc FX (vocal effects) modules; MIDI IN, MIDI OUT, and MIDI HOST ports connected to the MIDI processor; first and second microphone ports connected to the first and second Voc FX modules, respectively; a plurality of OUTPUT ports connected to the DSP; and first and second HOST ports connected to the DSP; wherein the audio interface provides multi-host redundancy, real-time signal processing and MIDI control,

### BACKGROUND OF THE INVENTION

The present invention is directed to audio interfaces used in live performances, and broadcast environments. Specifically, embodiments of this invention may combine multi-host redundant capabilities, real-time vocal pitch correction, advanced signal processing and MIDI control to meet the demands of professional applications.

An audio interface performs analog-to-digital conversion on audio inputs, such as microphones and instruments, provides the digital signals to host computers, and also performs digital-to-analog conversions to provide outputs, such as for speakers. Professional audio applications often demand exceptional reliability, versatility, and real-time processing capabilities. Traditional audio interfaces, while providing adequate functionality, struggle to meet these demands in critical scenarios such as live performances, broadcast applications, and mission-critical recordings and playback. Current solutions often involve complex setup with external pitch correction hardware or software, adding latency and complexity to the system. Modern live audio production workflows necessitate equipment with advanced features like real-time vocal processing and redundancy.

Existing audio interfaces typically provide a single connection, such as USB or Thunderbolt, to the host computer. However, if this single connection is interrupted or fails, the entire audio system becomes unusable, leading to potential loss of playback or recording. Traditional audio interfaces lack the ability to seamlessly switch between host devices, leading to potential interruptions in audio signal flow. Simultaneously, achieving flawless vocal performances, particularly in live settings, can be challenging without the assistance of real-time pitch correction. This invention may address these challenges by integrating redundancy, pitch correction, and advanced signal processing into a single, comprehensive audio interface system.

It would be desirable to have a multi-host redundant audio interface system for live settings.

### SUMMARY OF THE INVENTION

In one aspect of the present invention, an audio interface comprises a CPU (central processing unit) that includes a DSP (digital signal processor), a MIDI (musical instrument digital interface) processor, and two Voc FX (vocal effects) modules; MIDI IN, MIDI OUT, and MIDI HOST ports connected to the MIDI processor; first and second microphone ports connected to the first and second Voc FX modules, respectively; a plurality of OUTPUT ports connected to the DSP; and first and second HOST ports connected to the DSP; wherein the audio interface provides multi-host redundancy, real-time signal processing and MIDI control.

In another aspect of the present invention, an audio interface system comprises two host ports adapted to provide connections to a plurality of hosts; a dedicated controller that monitors the connections to the hosts and switches between the hosts in case of failure or disconnection to ensure uninterrupted operation; two voice effects modules that provide real-time vocal pitch correction for each of two microphone inputs; a plurality of output connections; MIDI IN, MIDI OUT, and MIDI HOST connections to provide MIDI functionality; and a front panel that includes an LCD display providing real-time feedback on system status, pitch correction activity, and signal levels.

### BRIEF DESCRIPTION OF THE DRAWINGS

FIG. 1 depicts a block diagram depicting the functional components of an embodiment of an audio interface.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

An embodiment of the present invention generally provides an audio interface system that may ensure uninterrupted audio signal flow through multi-host redundancy, also incorporating a real-time vocal pitch correction module and advanced signal processing algorithms. This integration may enhance the overall reliability, flexibility, and audio quality of the system for professional musicians, recording engineers, and live sound technicians.

Embodiments of the present invention may include multi-host redundancy, real-time vocal pitch correction, user interface and control, compatibility and connectivity, enhanced signal processing, and comprehensive MIDI functionality.

### Multi-Host Redundancy

An audio interface may include dual host connection ports (e.g., USB, Thunderbolt, and Ethernet) with automatic failover capabilities. A dedicated controller may continuously monitor the status of each host connection. Embodiments may quickly or seamlessly switch between the hosts in case of failure or disconnection to ensure uninterrupted operation.

### Real-Time Vocal Pitch Correction

A pitch correction module may employ one or more algorithms, including advanced algorithms, to analyze and correct pitch deviations in real-time, providing natural-sounding corrections without perceptible artifacts. In an embodiment, users can customize correction parameters, including pitch sensitivity, correction speed, and scale preferences, through an intuitive user interface. Controls may be provided so that users can remotely control the pitch shift parameters via MIDI. Embodiments may include advanced pitch detection and correction algorithms, which may provide or allow for a low latency for real-time performance.

### User Interface and Control

Embodiments may have a front panel that includes an LCD display providing real-time feedback on system status, pitch correction activity, and signal levels. Dedicated controls may allow users to manage host connections, adjust pitch correction settings, and monitor input/output levels.

### Compatibility and Connectivity

Embodiments of an audio interface may support a range of audio input and output formats, and accommodate various microphones, instruments, and professional audio systems. Connection options may include industry-standard interfaces such as USB 3.0, Thunderbolt 3, and Gigabit Ethernet for quick or seamless integration with a diverse range of host devices.

### Enhanced Signal Processing

Advanced signal processing algorithms may be employed in embodiments to provide high-quality audio enhancements and ultra-low latency processing. Controls may be provided to allow users to tailor signal processing settings to match the characteristics of their specific audio sources and production requirements.

### Comprehensive MIDI Functionality

Embodiments may include MIDI implementation. Embodiments may include 5-pin DIN MIDI input and output port and a USB MIDI Host port that allows for control and connection to a range of MIDI devices.

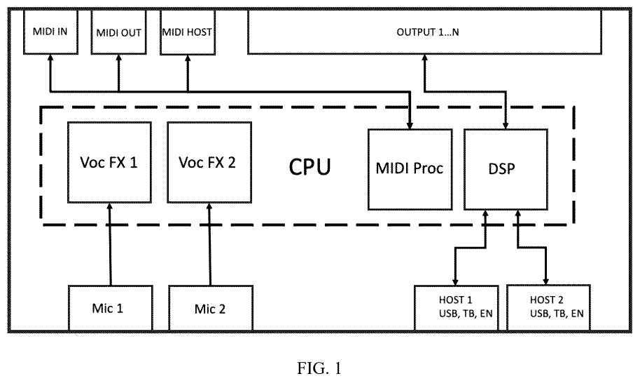

As depicted in FIG. 1, MIDI IN, MIDI OUT, and MIDI HOST ports may be connected to a MIDI Proc (musical instrument digital interface processor), which is part or module of a CPU (central processing unit). OUTPUT 1 . . . . N ports may connect to a DSP (digital signal processor), which is also part of the CPU. The DSP may further connect to HOST 1 and HOST 2 ports, which may support one more of USB (universal serial bus), TB (thunderbolt), and EN (Ethernet) interfaces. Mic 1 (microphone) and Mic 2 ports may connect to Voc FX 1 (vocal effects) and Vox FX 2 modules, respectively, which are both also part of the CPU.

Embodiments of the disclosed audio interface system represent a solution for professionals in the audio industry. By combining multi-host redundancy, real-time vocal pitch correction, and advanced signal processing and MIDI control, this invention may address the evolving needs of modern audio production, and may deliver a reliable, versatile, and high-performance tool for musicians, recording engineers, and live sound professionals.

I claim:

1. An audio interface, comprising:
a CPU (central processing unit) that includes a DSP (digital signal processor), a MIDI (musical instrument digital interface) processor, and two Voc FX (vocal effects) modules;
MIDI IN, MIDI OUT, and MIDI HOST ports connected to the MIDI processor;
first and second microphone ports connected to the first and second Voc FX modules, respectively;
a plurality of OUTPUT ports connected to the DSP; and
first and second HOST ports connected to the DSP;
wherein the audio interface provides multi-host redundancy, real-time signal processing and MIDI control.

2. The audio interface of claim 1, wherein:
the first host port supports a USB connection and the second host port supports a Thunderbolt connection.

3. The audio interface of claim 1, wherein:
the first host port supports a USB connection and the second host port supports an Ethernet connection.

4. The audio interface of claim 1, wherein:
the first and second host ports support different, non-compatible types of connection.

5. The audio interface of claim 1, wherein:
the DSP provides automatic switching in case of failure or disconnection of the HOST ports.

6. The audio interface of claim 1, wherein:
the DSP provides pitch detection and correction algorithms in real-time.

7. The audio interface of claim 1, further comprising:
a user interface to customize correction parameters, including pitch sensitivity, correction speed, and scale preferences.

8. The audio interface of claim 1, further comprising:
a user interface having a front panel with an LCD display providing real-time feedback on system status, pitch correction activity, and signal levels.

9. The audio interface of claim 1, further comprising:
an interface to customize correction parameters, including pitch sensitivity, correction speed, and scale preferences, via MIDI.

10. The audio interface of claim 1, further comprising:
an interface to customize correction parameters, including pitch sensitivity, correction speed, and scale preferences, including:
a 5-pin DIN MIDI IN connection,
a 5-pin DIN MIDI OUT connection, and
a USB MIDI HOST interface to provide MIDI functionality.

11. An audio interface system, comprising:
two host ports adapted to provide connections to a plurality of hosts;
a dedicated controller that monitors the connections to the hosts and switches between the hosts in case of failure or disconnection to ensure uninterrupted operation;
two voice effects modules that provide real-time vocal pitch correction for each of two microphone inputs;
a plurality of output connections;
MIDI IN, MIDI OUT, and MIDI HOST connections to provide MIDI functionality; and
a front panel that includes an LCD display providing real-time feedback on system status, pitch correction activity, and signal levels.
